(19) United States
(12) Patent Application Publication
(10) Pub. No.: US 2025/0110558 A1
(43) Pub. Date: Apr. 3, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventors: IKUO YAMANO, TOKYO (JP); TSUYOSHI ISHIKAWA, TOKYO (JP); SHIN SHIROMA, TOKYO (JP); KEIJIROH NAGANO, TOKYO (JP); RYO YOKOYAMA, TOKYO (JP)

(21) Appl. No.: 18/834,892

(22) PCT Filed: Jan. 26, 2023
(86) PCT No.: PCT/JP2023/002540

§ 371 Date: Jul. 31, 2024

(30) Foreign Application Priority Data
Feb. 8, 2022 (JP) 2022-018131

(51) Int. Cl. G06F 3/01

(52) U.S. Cl. CPC G06F 3/016; G06F 3/011

(57) ABSTRACT

An information processing apparatus (10) has a control unit (11). The control unit (11) controls, on the basis of a flexibility of an object, a presentation period of tactile feedback presented in response to a collision of the object.

### FIELD

The present invention relates to an information processing apparatus, an information processing method, and a program.

### BACKGROUND

A technique for artificially reproducing human cutaneous sensation (tactile sensation) by mechanical stimulation such as vibration is known. This type of technology is called haptics technology. The haptics technology is expected to be applied to XR (Extended Reality) and the like because it can realistically reproduce motion, texture, and the like of an object.

### CITATION LIST

### Patent Literature

Patent Literature 1: Japanese Translation of PCT International Application Laid-open No. H10-513593

### SUMMARY

### Technical Problem

In interaction with an object, visual and tactile feedback is performed on the basis of physical simulation. There are few established methods of tactile feedback based on physical simulation, and in particular, it is a fact that a method for expressing flexibility of an object has hardly been studied. Presentation time of a tactile stimulus is set to the same time as contact time in display video, but in consideration of the flexibility of an object, it is not always appropriate to match the presentation time of the tactile stimulus and the contact time of the display video.

Therefore, the present disclosure proposes an information processing apparatus, an information processing method, and a program capable of performing appropriate tactile feedback in consideration of flexibility of an object.

### Solution to Problem

According to the present disclosure, an information processing apparatus is provided that comprises a control unit that controls a presentation period of tactile feedback presented in response to a collision of an object on a basis of a flexibility of the object. According to the present disclosure, an information processing method in which an information process of the information processing apparatus is executed by a computer, and a program for causing the computer to execute the information process of the information processing apparatus, are provided.

### BRIEF DESCRIPTION OF DRAWINGS

FIG. 1 is a view for describing an outline of an information processing system using a haptic device.

FIG. 2 is a diagram illustrating one example of a configuration of the information processing apparatus.

FIG. 3 is a diagram for describing one example of information processing performed by the information processing apparatus.

FIG. 4 is a diagram for describing one example of the information processing performed by the information processing apparatus.

FIG. 5 is a diagram for describing one example of the information processing performed by the information processing apparatus.

FIG. 6 is a diagram for describing one example of the information processing performed by the information processing apparatus.

FIG. 7 is a diagram for describing one example of the information processing performed by the information processing apparatus.

FIG. 8 is a diagram for describing one example of the information processing performed by the information processing apparatus.

FIG. 9 is a diagram illustrating one example of a processing flow of the information processing apparatus.

FIG. 10 is a diagram illustrating an example of a hardware configuration of the information processing apparatus.

FIG. 11 is a view illustrating another application example of the information processing apparatus.

### DESCRIPTION OF EMBODIMENTS

Hereinafter, embodiments of the present disclosure will be described in detail with reference to the drawings. In the following embodiments, the same units are denoted by the same reference signs, and redundant description will be omitted.

Note that the description will be given in the following order.
[1. Outline of information processing system]
[2. Configuration of information processing apparatus]
[3. Information processing method]
[4. Example of hardware configuration]
[5. Effects]
[6. Other application examples]

### 1. Outline of Information Processing System

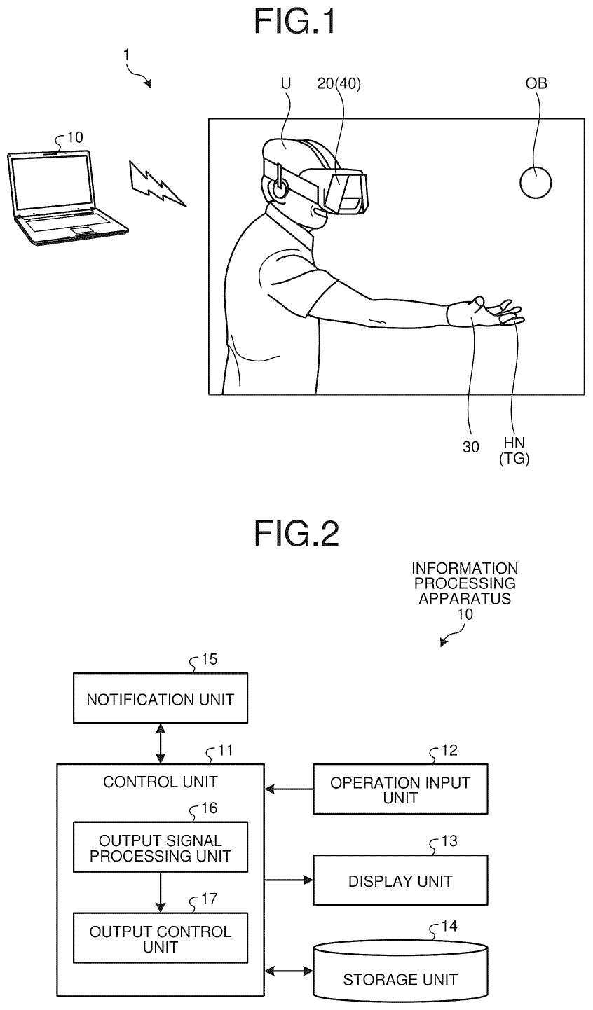

FIG. 1 is a view for describing an outline of an information processing system 1 using a haptic device 30.

The information processing system 1 has an information processing apparatus 10, a display device 20, the haptic device 30, and a sensor device 40.

The display device 20 provides video and audio to a user U. As the display device 20, a known wearable display such as a head mounted display or augmented reality (AR) glasses is used.

The haptic device 30 presents a tactile stimulus to the user U. As a method for presenting the tactile stimulus, a known method such as a piezoelectric method, an electrostatic method, and a pneumatic method is used. In the example of FIG. 1, the glove haptic device 30 with a pneumatic balloon at a position of a palm or a finger is illustrated. A tactile stimulus is provided by varying an air pressure inside the balloon.

The sensor device 40 includes various sensors for detecting self-position information. Examples of this type of sensor include a camera and a gyro sensor. The sensor device 40 is built in the display device 20, for example. The information processing apparatus 10 extracts the information (self-position information) regarding a position and a posture of the user U from sensor data using a known self-position estimation technique such as simultaneous localization and mapping (SLAM).

The information processing apparatus 10 performs various types of processing for performing interaction with an object OB. The object OB may be a real object existing in reality or a virtual object presented on the display device 20. In FIG. 1, a virtual ball generated by computer graphics (CG) is illustrated as an example of the object OB. The user U obtains a feeling of the object OB via the haptic device 30. The information processing apparatus 10 exchanges information with the display device 20, the haptic device 30, and the sensor device 40 via wireless communication.

### 2. Configuration of Information Processing Apparatus

FIG. 2 is a diagram illustrating one example of a configuration of the information processing apparatus 10.

The information processing apparatus 10 has a control unit 11, an operation input unit 12, a display unit 13, a storage unit 14, and a communication unit 15. The control unit 11 functions as an arithmetic processing apparatus and a control apparatus. The control unit 11 controls overall operation in the information processing apparatus 10 in accordance with various programs. The control unit 11 has an output signal processing unit 16 and an output control unit 17.

The output signal processing unit 16 generates output signals (a video signal, an acoustic signal, and a tactile signal) of the haptic device 30 and the display device 20 on the basis of a content acquired from a content server (not illustrated) or the storage unit 14. The tactile signal is a drive signal of an actuator for varying the air pressure of the balloon installed at the position of the palm or the finger.

The output control unit 17 outputs the generated output signals to the haptic device 30 and the display device 20 via the communication unit 15 at appropriate timing. The haptic device 30 applies a tactile stimulus to a hand HN of the user U on the basis of the tactile signal. As a result, tactile feedback regarding texture, movement, and the like of the object OB is performed. The display device 20 displays video on the basis of the video signal. As a result, visual feedback regarding the position, the movement, and the like of the object OB is performed.

The communication unit 15 communicates with the haptic device 30 and the display device 20 under the control of the output control unit 17. The communication unit 15 communicates with another device using, for example, a wired/wireless local area network (LAN), Wi-Fi (registered trademark), Bluetooth (registered trademark), short-distance wireless communication, a mobile communication network (Long Term Evolution (LTE) or 5G (fifth generation mobile communication scheme)), or the like.

The operation input unit 12 accepts an operation instruction by the user U and outputs an operation content to the control unit 11. Known input devices such as a touch sensor, a pressure sensor, and a proximity sensor are used as the operation input unit 12. The operation input unit 220 may have a physical configuration such as a keyboard, a mouse, a button, a switch, and a lever.

The display unit 13 displays various types of information on an application screen, a menu screen, and the like. As the display unit 13, a known display device such as a liquid crystal display (LCD) or an organic light emitting diode (OLED) is used.

The storage unit 14 stores programs, operation parameters, and the like used for processing of the control unit 11. The storage unit 14 can temporarily store a content acquired from a content server or the like.

### 3. Information Processing Method

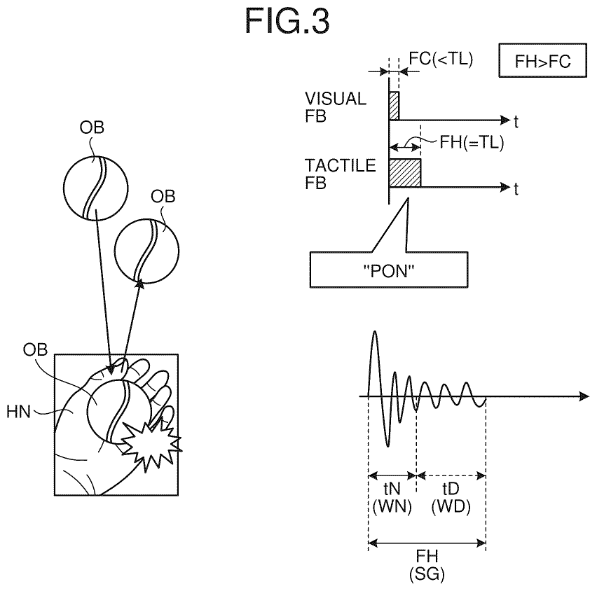

FIGS. 3 to 8 are diagrams for describing examples of information processing performed by the information processing apparatus 10.

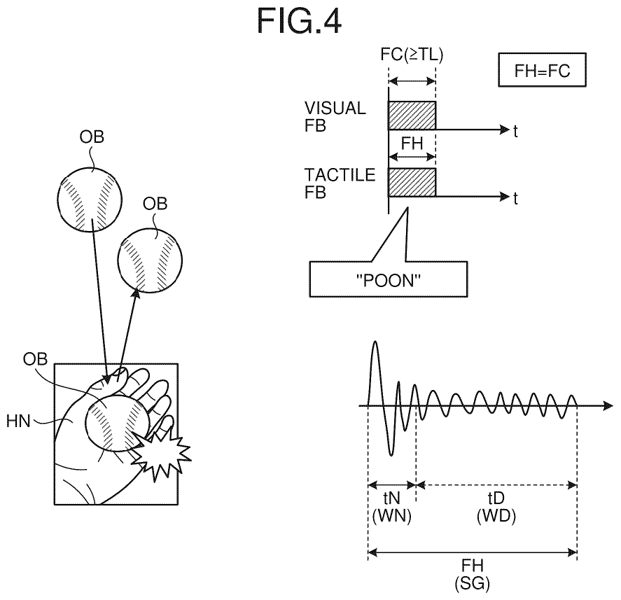

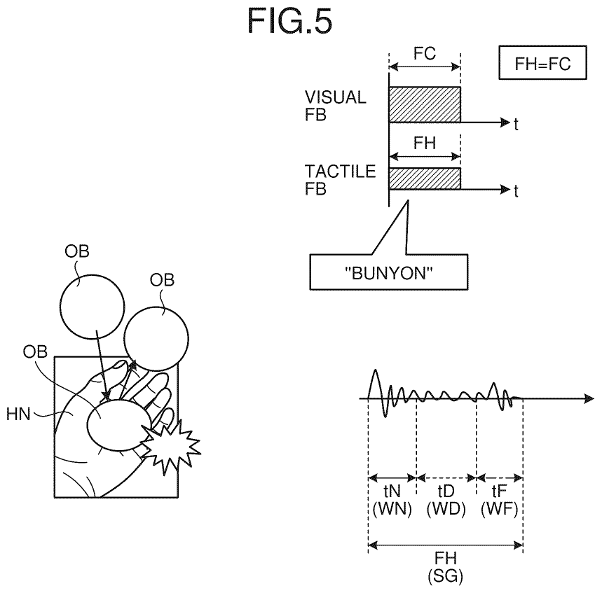

The control unit 11 controls a presentation period FH of the tactile feedback (tactile presentation period) presented in response to a collision of the object OB on the basis of a weight, a flexibility, and a collision speed of the object OB. FIGS. 3 and 4 illustrate an example in which a hard ball (a low flexible object) collides with the hand HN. FIGS. 5 to 8 illustrate an example in which a soft ball (a flexible object) collides with the hand HN. Hereinafter, an object that is a collision target of the object OB (the hand HN in the example of FIG. 1) is referred to as a collision object.

The collision speed is calculated as a relative speed between the object OB and the collision object. The weight is appropriately set in accordance with a type, a material, and the like of the object OB. For the object OB used in the game, the weight of the object OB may change in accordance with a progress of a game, attribute information of the user of the object OB, and the like. For example, a configuration can be considered in which in a case where a character throwing the ball is a large person, the ball becomes heavy, and the weight thereof is expressed by a magnitude of elastic deformation, deformation time, a vibration intensity, or a vibration duration. In addition, in a case where a number of revolutions of the ball is large, it is also possible to make setting in which the ball is light or the like.

The flexibility is determined on the basis of a preset flexibility criterion. Information regarding the flexibility criterion is stored in the storage unit 14. The flexibility criterion is determined for each type of the object OB. For example, in a case where the object OB is an elastic body such as a ball, if an elastic modulus is equal to or less than a preset criterion value, it is determined that the flexibility criterion is satisfied. Hereinafter, an object OB satisfying the flexibility criterion is referred to as a flexible object. The (hard) object OB whose elastic modulus is more than the criterion value and does not satisfy the flexibility criterion is referred to as a low flexible object.

The control unit 11 varies a vibration waveform of the tactile stimulus in accordance with the flexibility of the object OB. For example, in a case where the object OB is a flexible object (see FIGS. 5 to 8), the control unit 11 generates, as the vibration waveform of the tactile stimulus, a tactile signal SG including a vibration waveform WN at the time of contact ON, a vibration waveform WD during continuous contact, and a vibration waveform WF at the time of contact OFF. For example, in a case where the object OB is a low flexible object (see FIGS. 3 and 4), the control unit 11 generates, as the vibration waveform of the tactile stimulus, the tactile signal SG selectively including the vibration waveform WN at the time of contact ON and the vibration waveform WD during continuous contact.

An amplitude and a frequency of vibration are calculated on the basis of the weight, the flexibility, and the collision speed of the object OB. Processing of waveform calculation may be performed at the time of collision, or may be performed before the collision by predicting the collision from a trajectory of the object OB.

The vibration waveform WN at the time of contact ON is a vibration waveform corresponding to a moment tN when the object OB is contacted. The vibration waveform WD during continuous contact is a vibration waveform corresponding to a contact duration tD with the object OB. The vibration waveform WF at the time of contact OFF is a vibration waveform corresponding to a moment tF when the object OB moves away.

The vibration waveform WN at the time of contact ON is generated as a vibration waveform whose the amplitude is momentarily more than the vibration waveform WD during continuous contact at the timing of collision of the object OB. The vibration waveform WF at the time of contact OFF is generated as a vibration waveform whose amplitude is momentarily more than the vibration waveform WD during continuous contact at the timing of rebound of the object OB. As a result, an impact at the time of collision and a repulsion due to an elastic restoring force at the time of rebound are realistically reproduced.

The amplitude at the time of the collision and the amplitude at the time of rebound are determined on the basis of the weight, the flexibility, and the collision speed of the object OB. In order to make the user U perceive the collision and the rebound, it is desirable that the amplitude at the time of collision and the amplitude at the time of rebound are sufficiently more than the vibration waveform WD during continuous contact. For example, the amplitude at the time of collision and the amplitude at the time of rebound are set to twice or more an average value of the amplitude of the vibration waveform WD during continuous contact. Thereby, the timing of the collision and the timing of the rebound of the flexible object are clearly perceived.

In a case where the object OB is a low flexible object (see FIGS. 3 and 4), the tactile signal SG does not include the vibration waveform WF at the time of contact OFF. This is because a large repulsion due to the elastic restoring force does not occur in the low flexible object, which is hardly deformed.

That is, in the soft object, a large elastic restoring force is generated by deformation at the time of collision. The elastic restoring force directly becomes a repulsive force, and causes the object OB to greatly rebound. A specific feeling such as repelling the hand HN by a repulsive force is reproduced by the vibration waveform WF at the time of contact OFF. However, since the deformation at the time of collision is small in the low flexible object, only a feeling that the object OB sinks into the hand HN can be obtained, and a specific feeling such as repelling the hand HN cannot be obtained. Therefore, the vibration waveform WF at the time of contact OFF that reproduces the feeling of rebound at the time of rebound is omitted.

The user U recognizes the contact between the hand HN and the object OB by the video of the display device 20. The user acquires the contact with the object OB presented as the video as the visual feedback. The control unit 11 calculates contact time between the hand HN and the object OB using physical simulation. The control unit 11 determines the calculated contact time as a presentation period FC of the visual feedback regarding the contact with the object OB.

The control unit 11 calculates the presentation period FC of the visual feedback on the basis of the weight, the flexibility, and the collision speed of the low flexible object. The control unit 11 adjusts a magnitude of the presentation period FH of the tactile feedback in accordance with the magnitude of the presentation period FC of the visual feedback.

For example, the object OB in FIG. 3 is very hard, and the contact time (the presentation period FC of the visual feedback) in contact with the hand HN is also very short. The object OB of FIG. 4 is softer than the object OB of FIG. 3, and thus, the presentation period FC of the visual feedback is also longer than the example of FIG. 3. The control unit 11 compares the presentation period FC of the visual feedback with a preset threshold TL, and adjusts the presentation period FH of the tactile feedback on the basis of a comparison result.

For example, in the example of FIG. 3, the presentation period FC of the visual feedback is less than the preset threshold TL. In this case, the control unit 11 matches the presentation period FH of the tactile feedback with the threshold TL. In the example of FIG. 4, the presentation period FC of the visual feedback is more than or equal to the threshold TL. In this case, the control unit 11 matches the presentation period FH of the tactile feedback with the presentation period FC of the visual feedback.

A magnitude of the threshold value TL is set on the basis of a limit value of human perception ability to perceive a collision of the object OB. The magnitude of the threshold value TL may be set on the basis of a sensory test or the like. In the low flexible object, the deformation at the time of collision is small, and thus the contact time with the hand HN becomes short. In a very hard object OB, the contact time is very short, and if the presentation period FH of the tactile feedback is set in accordance with the contact time, the tactile stimulus may be so small that it cannot be perceived. However, in the configuration of the present disclosure, the presentation period FH of the tactile feedback is not set to a short period that cannot be perceived by a human. Therefore, the collision of the object OB is reliably perceived by the user U.

In a case where the object OB is a flexible object, the above-described adjustment is not performed. In the flexible object, the deformation at the time of collision is large, and thus the contact time with the hand HN also becomes long. Therefore, it is considered that the collision of the object OB is reliably perceived by the user U. Thus, the control unit 11 matches the presentation period FH of the tactile feedback with the presentation period FC of the visual feedback (the contact time between the hand HN and the object OB).

As described before, in a case where the object OB is a flexible object, the control unit 11 generates the tactile signal SG as a signal including the vibration waveform WN at the time of contact ON, the vibration waveform WD during continuous contact, and the vibration waveform WF at the time of contact OFF (see FIGS. 5 to 8).

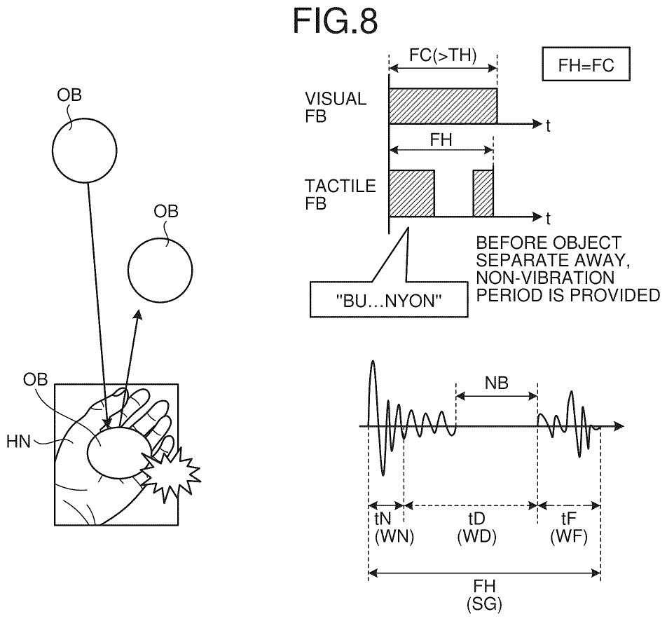

In the examples of FIGS. 5 to 8, the collision speed of the object OB becomes large in the order of FIGS. 5, 6, and 8. As the collision speed becomes larger, the contact duration tD becomes longer, and a load on an actuator for generating the tactile stimulus becomes larger. Therefore, as illustrated in FIG. 8, in a case where the presentation period FC of the visual feedback is more than a preset threshold TH, the control unit 11 generates the vibration waveform WD during continuous contact including a non-vibration period NB within the contact duration tD. The non-vibration period NB is a period in which the amplitude is substantially zero. This reduces the load on the actuator. In addition, by providing the non-vibration period NB, a feeling that deformation reaches a saturation state and further deformation is stopped is reproduced. Therefore, it is possible to realistically reproduce a feeling when the object OB is greatly deformed.

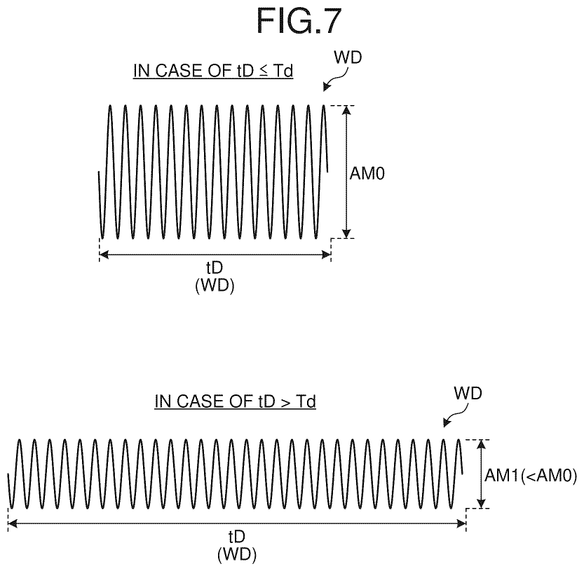

Note that, as illustrated in FIG. 7, even when the presentation period FC of the visual feedback is equal to or less than the threshold TH, the vibration waveform of the tactile signal SG can be adjusted to protect the actuator. For example, in a case where the contact duration tD is more than a preset threshold Id, the control unit 11 can generate the vibration waveform WD during continuous contact, which has an amplitude less than that in a case where the contact duration tD is equal to or less than the threshold Td. The threshold value Td is, for example, five seconds, but a length of the threshold value Id is not limited thereto. The threshold value Id is arbitrarily set in accordance with a type of actuator or the like.

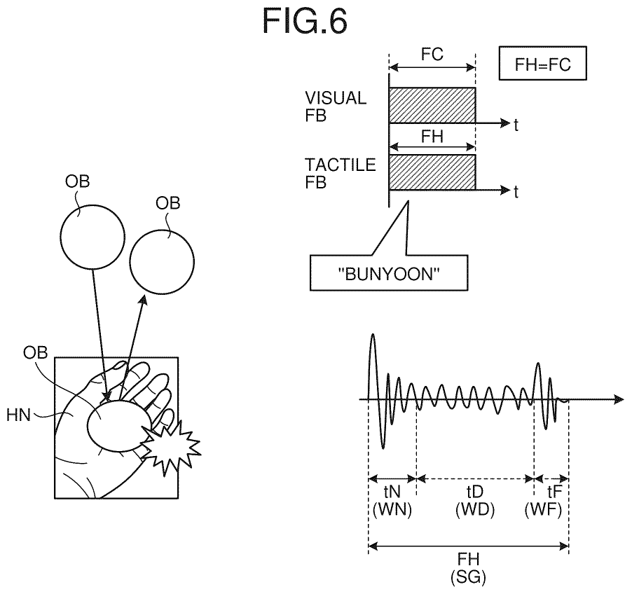

In the example of FIG. 7, the collision of the object OB is performed at a speed similar to that in FIG. 6. In the physical simulation, an amplitude AM0 is calculated as the amplitude in the contact duration tD. In a case where the contact duration tD is equal to or less than the threshold Td, the vibration waveform WD during continuous contact that has the amplitude AM0 calculated by the physical simulation is generated (see an upper view of FIG. 7). However, in a case where the contact duration tD is more than the threshold Td, the vibration waveform WD during continuous contact that has an amplitude AM1 less than the amplitude AM0 calculated by the physical simulation is generated (see a lower view of FIG. 7).

In the examples of FIGS. 5 to 8, the presentation period FH of the tactile feedback is controlled on the basis of the weight, the flexibility, and the collision speed of the object OB. However, the control unit 11 can also control the presentation period FH of the tactile feedback in consideration of the flexibility of the collision object (the hand HN in the example of FIG. 1) that collides with the object OB.

For example, a hardness of the hand HN differs between a state in which the hand HN is opened and a state in which the hand HN is firmly clasped. An amount of deformation of the object OB, that is, the period during which the tactile feedback should be presented becomes more when the object OB collides with a hard first than when the object OB collides with a palm. By considering a hardness of the collision object that varies depending on a form of the collision object, more appropriate tactile feedback is provided.

The control unit 11 can also change characteristics of the object OB in accordance with parameters of an actual environment in which the collision is performed. For example, the control unit 11 changes the flexibility of the object OB in accordance with a temperature of the object OB at the time of collision. In a case where the temperature of the actual environment of an AR experience is low, the elastic modulus of the object OB is set high accordingly. Furthermore, in a case where the temperature of the object OB virtually rises by repeating the collision, the elastic modulus of the object OB is set to be low accordingly. As a result, realistic tactile feedback in accordance with the temperature is performed.

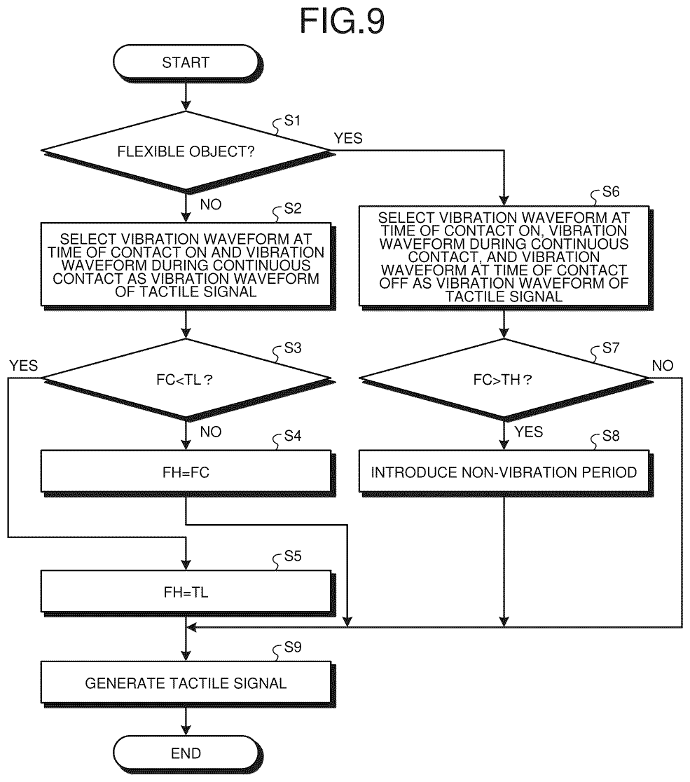

FIG. 9 is a diagram illustrating one example of a configuration of the information processing apparatus 10.

The control unit 11 determines whether or not the object OB that collides with the hand HN is a flexible object satisfying the flexibility criterion (Step S1).

In a case where the object OB is a low flexible object that does not satisfy the flexibility criterion (Step S1: No), the control unit 11 selects the vibration waveform WN at the time of contact ON and the vibration waveform WD during continuous contact as the vibration waveform of the tactile stimulation (Step S2).

In a case where the object OB is a low flexible object, the control unit 11 determines whether or not the presentation period FC of the visual feedback is less than the threshold TL (Step S3).

In a case where the presentation period FC of the visual feedback is equal to or more than the threshold TL (Step S3: No), the control unit 11 matches the presentation period FH of the tactile feedback with the presentation period FC of the visual feedback (Step S4). In a case where the presentation period FC of the visual feedback is less than the threshold TL (Step S3: Yes), the control unit 11 matches the presentation period FH of the tactile feedback with the threshold TL (Step S5).

The control unit 11 generates the tactile signal SG by using the presentation period FH of the tactile feedback and the information of the vibration waveform (Step S9).

In a case where the object OB is a flexible object (Step S1: Yes), the control unit 11 selects, as the vibration waveform of the tactile stimulation, the vibration waveform WN at the time of contact ON, the vibration waveform WD during continuous contact, and the vibration waveform WF at the time of contact OFF (Step S6).

In a case where the object OB is a flexible object, the control unit 11 determines whether or not the presentation period FC of the visual feedback is more than the threshold TH (Step S7). In a case where the presentation period FC of the visual feedback is more than the threshold TH (Step S7: Yes), the control unit 11 introduces the non-vibration period NB within the contact duration. In a case where the presentation period FC of the visual feedback is equal to or less than the threshold TH (Step S7: No), the control unit 11 does not introduce the non-vibration period NB within the contact duration.

The control unit 11 generates the tactile signal SG by using the information on the vibration waveform and the information on the presence or absence of the non-vibration period NB (Step S9).

### 4. Example of Hardware Configuration

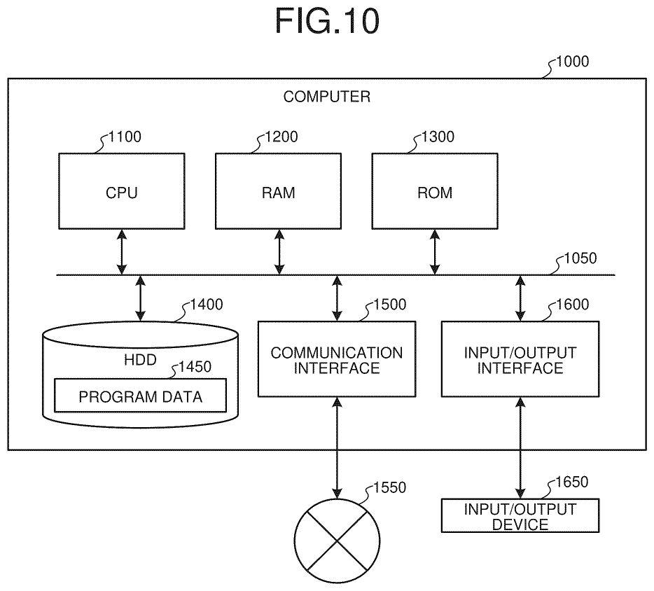

FIG. 10 is a diagram illustrating an example of a hardware configuration of the information processing apparatus 10.

The information processing apparatus 10 is implemented by a computer 1000. The computer 1000 has a CPU 1100, a RAM 1200, a read only memory (ROM) 1300, a hard disk drive (HDD) 1400, a communication interface 1500, and an input/output interface 1600. Each of the units of the computer 1000 is connected by a bus 1050.

The CPU 1100 operates on the basis of programs stored in the ROM 1300 or the HDD 1400, and controls each of the units. For example, the CPU 1100 develops, in the RAM 1200, the programs stored in the ROM 1300 or the HDD 1400, and executes processing corresponding to the various programs.

The ROM 1300 stores a boot program of a basic input output system (BIOS) or the like executed by the CPU 1100 when the computer 1000 is activated, a program depending on hardware of the computer 1000, and the like.

The HDD 1400 is a computer-readable recording medium that non-transiently records a program executed by the CPU 1100, data used by the program (including various databases), and the like. Specifically, the HDD 1400 is a recording medium that records an information processing program according to the present disclosure as one example of program data 1450.

The communication interface 1500 is an interface for the computer 1000 to connect to an external network 1550 (for example, the Internet). For example, the CPU 1100 receives data from other equipment or transmits data generated by the CPU 1100 to other equipment via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded on a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 10, the CPU 1100 of the computer 1000 implements the above-described various functions by executing a program loaded on the RAM 1200. In addition, the HDD 1400 stores a program for causing the computer to function as the information processing apparatus 10. Note that the CPU 1100 reads the program data 1450 from the HDD 1400 and executes the program data, but as another example, these programs may be acquired from another apparatus via the external network 1550.

### 5. Effects

The information processing apparatus 10 includes the control unit 11. The control unit 11 controls a presentation period FH of the tactile feedback presented in response to a collision of the object OB on the basis of the flexibility of the object OB. In the information processing method of the present disclosure, the processing of the information processing apparatus 10 is executed by the computer 1000. The program of the present disclosure causes the computer 1000 to implement the processing of the information processing apparatus 10.

According to this configuration, appropriate tactile feedback in consideration of the flexibility of the object OB is performed.

In a case where the object OB is a flexible object that satisfies the flexibility criterion, the control unit 11 generates, as the vibration waveform of the tactile stimulation, the tactile signal SG including the vibration waveform WN at the time of contact ON, the vibration waveform WD during continuous contact, and the vibration waveform WF at the time of contact OFF.

According to this configuration, the flexibility of the flexible object is better represented.

In a case where the presentation period FC of the visual feedback calculated on the basis of the flexibility of the flexible object is more than the threshold TH, the control unit 11 generates the vibration waveform WD during continuous contact including the non-vibration period NB within the contact duration tD.

According to this configuration, the feeling that the deformation reaches the saturation state and the further deformation is stopped is reproduced. Therefore, it is possible to realistically reproduce the feeling when the object OB is greatly deformed.

In a case where the contact duration tD is more than the preset threshold Td, the control unit 11 generates the vibration waveform WD during continuous contact, which has an amplitude less than that in a case where the contact duration tD is equal to or less than the threshold Td.

According to this configuration, it is possible to protect a vibrator (the actuator of the haptic device 30 that generates the tactile stimulus) while the feeling at the time of deformation of the object OB is realistically reproduced.

In a case where the object OB is a low flexible object that does not satisfy the flexibility criterion, the control unit 11 generates, as the vibration waveform of the tactile stimulus, the tactile signal SG selectively including the vibration waveform WN at the time of contact ON and the vibration waveform WD during continuous contact.

According to this configuration, the hardness of the object OB is realistically reproduced.

In a case where the presentation period FC of the visual feedback calculated on the basis of the flexibility of a low flexibility object is less than the threshold TL, the control unit 11 matches the presentation period FH of the tactile feedback with the threshold TL. In a case where the presentation period FC of the visual feedback is equal to or more than the threshold TL, the control unit 11 matches the presentation period FH of the tactile feedback with the presentation period FC of the visual feedback.

According to this configuration, the presentation period FH of the tactile feedback is not excessively shortened. Therefore, the user U can reliably perceive the object OB on the basis of the tactile stimulus.

The control unit 11 controls the presentation period FH of the tactile feedback in consideration of the flexibility of the collision object that collides with the object OB.

According to this configuration, a deformation state of the object OB that changes depending on the flexibility (hardness) of the collision object is realistically reproduced through the tactile stimulation.

The control unit 11 changes the flexibility of the object OB in accordance with the temperature of the object OB at the time of collision.

According to this configuration, the deformation state of the object OB in accordance with the temperature is realistically reproduced through the tactile stimulation.

Note that the effects described in the present specification are merely examples and are not limited, and other effects may be provided.

### 6. Other Application Examples

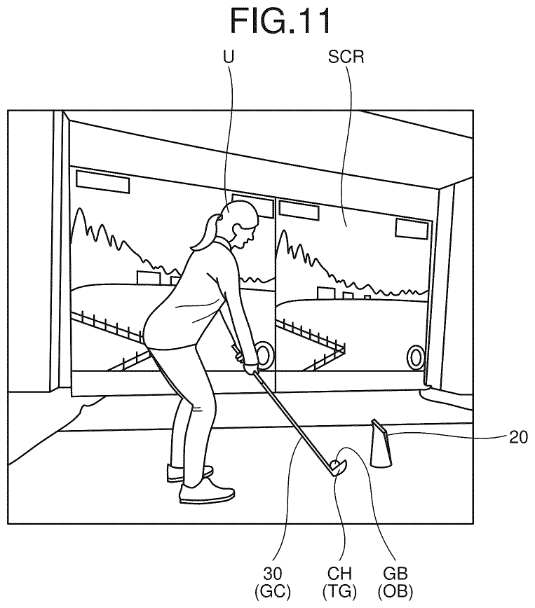

FIG. 11 is a view illustrating another application example of the information processing apparatus 10.

In the example of FIG. 1, the tactile control method of the present disclosure is applied to the operation of the virtual object. However, the object OB to be operated is not limited to the virtual object. In the example of FIG. 11, the tactile control method of the present disclosure is applied to operation of a real object existing in reality.

An information processing system in FIG. 11 performs a golf simulation using an actual golf club GC and an actual golf ball GB. The display device 20 projects scenery of a golf course onto a screen SCR. The user U hits the golf ball GB toward the screen SCR using the golf club GC. The control unit 11 analyzes swing using a sensor such as a camera and reproduces a trajectory of the golf ball GB on the screen SCR.

The golf club GC incorporates the haptic device 30. The control unit 11 calculates a collision speed between a club head CH (a collision object TG) and the golf ball GB on the basis of an analysis result of the swing. A weight and a flexibility of the golf ball GB can be set on a system side. The control unit 11 controls the vibration waveform of the tactile signal SG on the basis of the weight, the flexibility, and the collision speed of the golf ball GB. The object OB to be operated is the golf ball GB which is a real object, and realistic tactile feedback can be obtained by processing similar to the example of FIG. 1.

Note that in the above-described example, control of the tactile feedback and the visual feedback according to the flexibility of the object OB is performed. This control method is applicable to other than the tactile feedback and the visual feedback. For example, auditory feedback may be performed using a similar method.

### SUPPLEMENTARY NOTE

Note that the present technology can also have configurations below.

(1)

An information processing apparatus comprising: a control unit that controls a presentation period of tactile feedback presented in response to a collision of an object on a basis of a flexibility of the object.

(2)

The information processing apparatus according to (1), wherein
in a case where the object is a flexible object that satisfies a flexibility criterion, the control unit generates, as a vibration waveform of a tactile stimulus, a tactile signal including a vibration waveform at the time of contact ON corresponding to a moment of contact with the object, a vibration waveform during continuous contact corresponding to a contact duration with the object, and a vibration waveform at the time of contact OFF corresponding to a moment of separation of the object.
   (3)

The information processing apparatus according to (2), wherein
in a case where a presentation period of visual feedback calculated on a basis of a flexibility of the flexible object is more than a first threshold, the control unit generates the vibration waveform during continuous contact including a non-vibration period within the contact duration.
   (4)

The information processing apparatus according to (3), wherein
in a case where the contact duration is more than a second threshold, the control unit generates the vibration waveform during continuous contact having an amplitude less than that in a case where the contact duration is equal to or less than the second threshold.
   (5)

The information processing apparatus according to any one of (2) to (4) wherein
in a case where the object is a low flexible object that does not satisfy the flexibility criterion, the control unit generates, as the vibration waveform of the tactile stimulus, a tactile signal selectively including the vibration waveform at the time of contact ON and the vibration waveform during continuous contact.
   (6)

The information processing apparatus according to (5), wherein
in a case where the presentation period of the visual feedback calculated on the basis of the flexibility of the low flexible object is less than a third threshold, the control unit matches the presentation period of the tactile feedback with the third threshold, and in a case where the presentation period of the visual feedback is equal to or more than the third threshold, the control unit matches the presentation period of the tactile feedback with the presentation period of the visual feedback.
   (7)

The information processing apparatus according to any one of (1) to (6), wherein
the control unit controls the presentation period of the tactile feedback in consideration of a flexibility of a collision object that collides with the object.
   (8)

The information processing apparatus according to any one of (1) to (7), wherein
the control unit changes the flexibility of the object in accordance with a temperature of the object at the time of collision.
   (9)

An information processing method executed by a computer, the method comprising controlling, on a basis of a flexibility of an object, a presentation period of tactile feedback presented in response to a collision of the object.

(10)

A program that causes a computer to implement controlling, on a basis of a flexibility of an object, a presentation period of tactile feedback presented in response to a collision of the object.

### REFERENCE SIGNS LIST

10 INFORMATION PROCESSING APPARATUS
11 CONTROL UNIT
FC PRESENTATION PERIOD OF VISUAL FEEDBACK
FH PRESENTATION PERIOD OF TACTILE FEEDBACK
NB NON-VIBRATION PERIOD
OB OBJECT
SG TACTILE SIGNAL
tD CONTACT DURATION
Td THRESHOLD (SECOND THRESHOLD)
TH THRESHOLD (FIRST THRESHOLD)
TL THRESHOLD (THIRD THRESHOLD)
WD VIBRATION WAVEFORM DURING CONTINUOUS CONTACT
WF VIBRATION WAVEFORM AT THE TIME OF CONTACT OFF
WN VIBRATION WAVEFORM AT THE TIME OF CONTACT ON

1. An information processing apparatus comprising: a control unit that controls a presentation period of tactile feedback presented in response to a collision of an object on a basis of a flexibility of the object.

2. The information processing apparatus according to claim 1, wherein
in a case where the object is a flexible object that satisfies a flexibility criterion, the control unit generates, as a vibration waveform of a tactile stimulus, a tactile signal including a vibration waveform at the time of contact ON corresponding to a moment of contact with the object, a vibration waveform during continuous contact corresponding to a contact duration with the object, and a vibration waveform at the time of contact OFF corresponding to a moment of separation of the object.

3. The information processing apparatus according to claim 2, wherein
in a case where a presentation period of visual feedback calculated on a basis of a flexibility of the flexible object is more than a first threshold, the control unit generates the vibration waveform during continuous contact including a non-vibration period within the contact duration.

4. The information processing apparatus according to claim 3, wherein
in a case where the contact duration is more than a second threshold, the control unit generates the vibration waveform during continuous contact having an amplitude less than that in a case where the contact duration is equal to or less than the second threshold.

5. The information processing apparatus according to claim 2, wherein
in a case where the object is a low flexible object that does not satisfy the flexibility criterion, the control unit generates, as the vibration waveform of the tactile stimulus, a tactile signal selectively including the vibration waveform at the time of contact ON and the vibration waveform during continuous contact.

6. The information processing apparatus according to claim 5, wherein
in a case where the presentation period of the visual feedback calculated on the basis of the flexibility of the low flexible object is less than a third threshold, the control unit matches the presentation period of the tactile feedback with the third threshold, and in a case where the presentation period of the visual feedback is equal to or more than the third threshold, the control unit matches the presentation period of the tactile feedback with the presentation period of the visual feedback.

7. The information processing apparatus according to claim 1, wherein
the control unit controls the presentation period of the tactile feedback in consideration of a flexibility of a collision object that collides with the object.

8. The information processing apparatus according to claim 1, wherein
the control unit changes the flexibility of the object in accordance with a temperature of the object at the time of collision.

9. An information processing method executed by a computer, the method comprising controlling, on a basis of a flexibility of an object, a presentation period of tactile feedback presented in response to a collision of the object.

10. A program that causes a computer to implement controlling, on a basis of a flexibility of an object, a presentation period of tactile feedback presented in response to a collision of the object.
